(19) United States
(12) Patent Application Publication
(10) Pub. No.: US 2021/0086616 A1
(43) Pub. Date: Mar. 25, 2021

(54) CONTROL DEVICE FOR CONTROLLING A TOUCH-SENSITIVE SURFACE FOR A VEHICLE, SURFACE CONTROL DEVICE COMPRISING A CONTROL DEVICE, AND METHOD AND CONTROL UNIT FOR OPERATING A TOUCH-SENSITIVE SURFACE BY MEANS OF A CONTROL DEVICE

(71) Applicant: ZF Friedrichshafen AG, Friedrichshafen (DE)

(72) Inventors: Vitali FRIBUS, Quakenbrück (DE); Alex HESSEL, Lemförde (DE)

(73) Assignee: ZF Friedrichshafen AG, Friedrichshafen (DE)

(21) Appl. No.: 16/630,389

(22) PCT Filed: Jun. 20, 2018
(86) PCT No.: PCT/EP2018/066329

§ 371 Date: Jan. 10, 2020

(30) Foreign Application Priority Data
Jul. 13, 2017 (DE) 10 2017 212 056.8

(51) Int. Cl. B60K 37/06; B60K 37/02

(52) U.S. Cl. CPC B60K 37/06; B60K 37/02; B60K 2370/126; B60K 2370/52; B60K 2370/133; B60K 2370/695; B60K 2370/1438

(57) ABSTRACT

The present invention relates to a control device for operating a touch-sensitive surface in a vehicle. The control device has a navigating element. The navigating element is or can be moveably coupled to the surface such that it is possible to navigate on the surface and/or operate at least one button on the surface in response to a movement of the navigating element.

The present invention relates to a control device for operating a touch-sensitive surface in a vehicle, a surface control device comprising a control device, and a method and a control unit for operating a touch-sensitive surface by means of a control device.

Multi-touch touchscreens are increasingly used in vehicles for controlling driving functions of a vehicle, which are operated by the driver of the vehicle.

Based on this, the present invention creates an improved control device for operating a touch-sensitive surface in a vehicle, an improved surface control device that has a control device, and an improved method and control unit for operating a touch-sensitive surface by means of a control device according to the independent claims. Advantageous embodiments can be derived from the dependent claims and the following description.

The advantage obtained with the present invention is that a touch-sensitive surface can be operated by a control device presented herein, which allows for very precise inputs. Driving safety can be improved therewith.

A control device for operating a touch-sensitive surface in a vehicle contains a navigating element. The touch-sensitive surface can be a multi-touch touchscreen, by means of which the driving functions of the vehicle can be adjusted. The navigating element is or can be moveably coupled to the surface, and is configured such that is possible to navigate on the surface and/or operate at least a push button on the surface in response to a movement of the navigating element. The operation of the push button can be understood to be a marking or selection of the push button, and/or actuation of a driving function of the vehicle assigned to the marked or selected push button, for example.

The navigating element is or can be designed to rotate and/or move linearly on the surface. The navigating element can have one or more snap-in pins for fastening the navigating element to the surface, which are designed to engage in a snap-in contour. The navigating element can also have one or two metal surfaces, one of which is moved to a permanent magnet on the surface when the navigating element is moved linearly. The metal surface can then be moved away from the permanent magnet by moving it linearly in the other direction, thus moving the other surface toward the permanent magnet. This allows the navigating element to be moved to different positions or locations on the surface. By way of example, the navigating element can comprise a dial and/or slider, and/or control lever that can be moved in the manner described above.

To transmit a position or location of the control device on the surface to a control unit for the surface, for example, it is advantageous when the navigating element has at least one pin that is in contact with the surface when the navigating element is coupled to the surface. The pin can be a conductive pin that is brought into contact with the surface via a spring mechanism in the dial, for example. The navigating element can also have numerous such pins, which can be arranged such that at least two of the pins are always in contact with the surface, in order to always be able to check that the functions of the surface are working properly.

In addition, the control device according to an advantageous embodiment can also have a keypad with buttons, in particular wherein the keypad is accommodated in the navigating element. The keypad can also contain a conductive button pin that is in contact with the surface in at least one position of the navigating element when it is coupled to the surface. As a result, a button marked or selected by the navigating element can be actuated in response to an actuation of the keypad, for example.

A surface control device comprises such a control device and touch-sensitive surface, wherein the control device is moveably coupled to the surface.

It is advantageous when the operation of the surface through the movement of the navigating element is dependent on a defined contact position of at least one conductive pin and/or a second conductive pin in the navigating element on the surface.

A method for operating a touch-sensitive surface by means of one of the variations of the control device described above comprises at least the following steps:

Inputting a movement signal that represents the movement of the navigating element of the control device coupled to the surface; and

Outputting a navigation signal for navigating on the surface and/or operating the button on the surface based on the movement signal.

A corresponding control unit is configured to execute and/or initiate the steps of the method in corresponding units. The control unit can be an electrical device that processes electrical signals, e.g. sensor signals, and output control signals based thereon. The control unit can have one or more hardware and/or software interfaces. A hardware interface can be part of an integrated circuit, for example, in which the functions of the control unit are implemented. The interfaces can also be individual integrated circuits, or be made at least in part of discrete components. Software interfaces can be software modules, e.g. in a microcontroller, in addition to other software modules.

A computer program product with program code that can be stored on a machine-readable medium, e.g. a solid state drive, a hard drive, or an optical drive, and used for executing the method according to any of the embodiments described above when the program is executed on a computer or control unit is also advantageous.

Exemplary embodiments of the present invention are illustrated in the drawings, and explained in greater detail below. Therein:

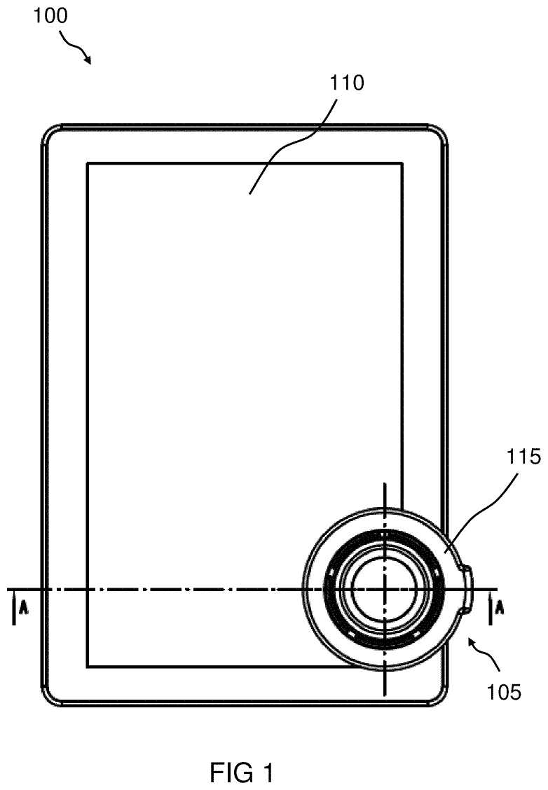

FIG. 1 shows a schematic top view of a surface control device comprising a control device for operating a touch-sensitive surface in a vehicle according to an exemplary embodiment;

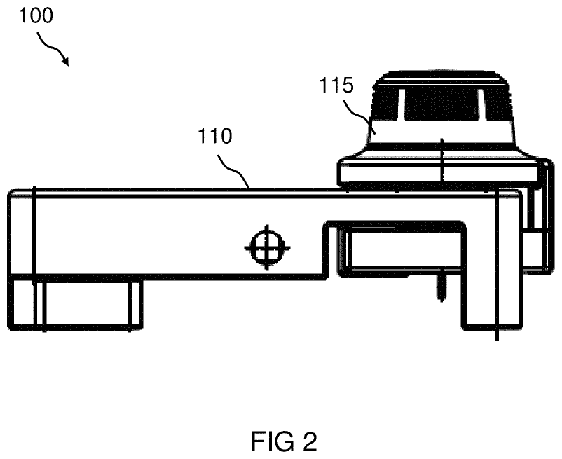

FIG. 2 shows a schematic illustration of an undersurface of a surface control device according to an exemplary embodiment;

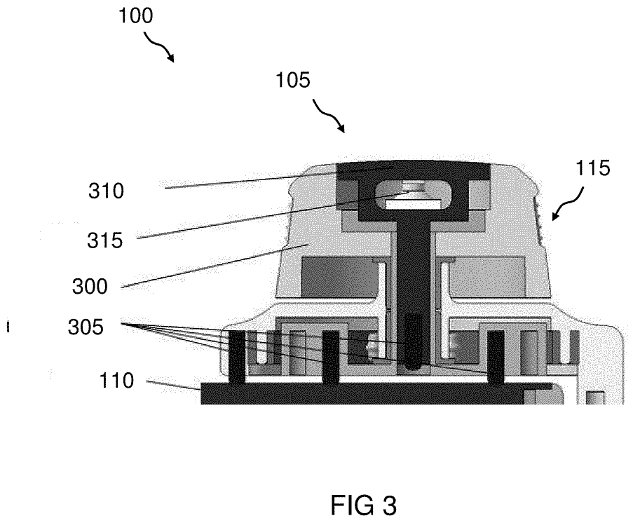

FIG. 3 shows a schematic cross sectional illustration of a control device according to an exemplary embodiment;

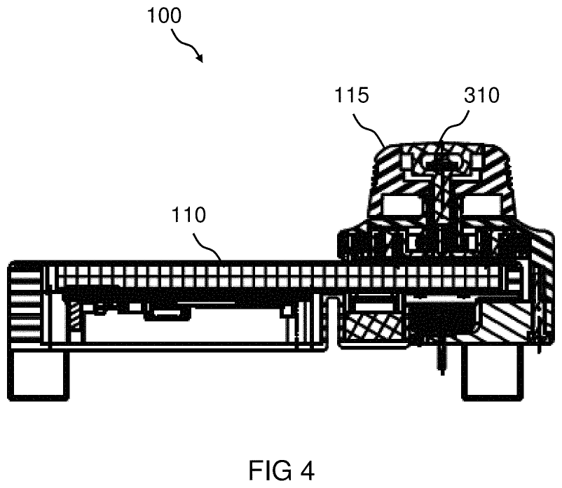

FIG. 4 shows a schematic cross sectional illustration of a surface control device according to an exemplary embodiment;

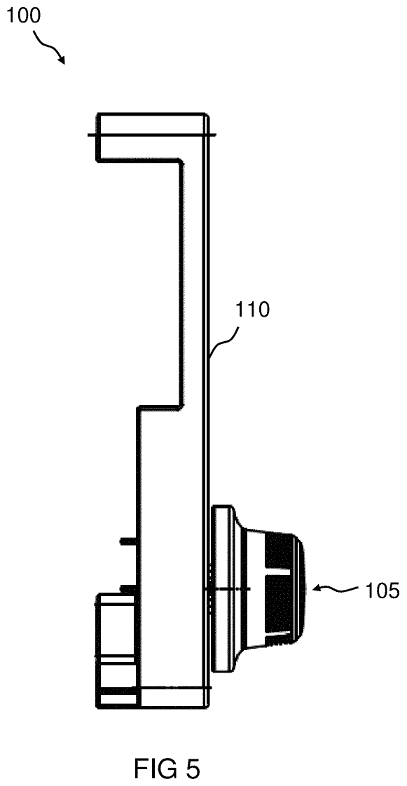

FIG. 5 shows a schematic side view of a surface control device according to an exemplary embodiment;

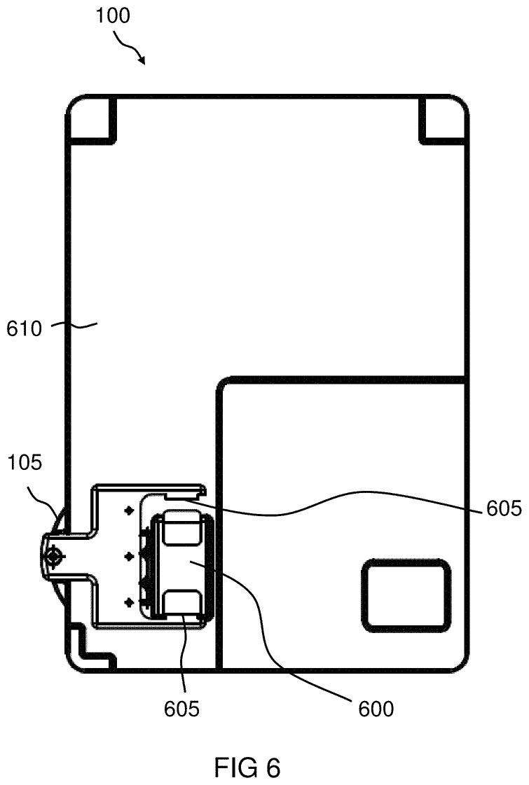

FIG. 6 shows a schematic rear view of a surface control device according to an exemplary embodiment;

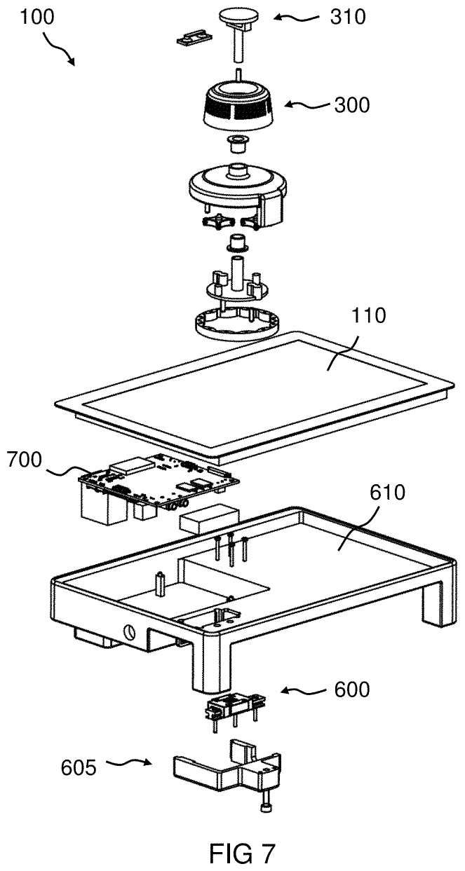

FIG. 7 shows a perspective, exploded view of a surface control device according to an exemplary embodiment;

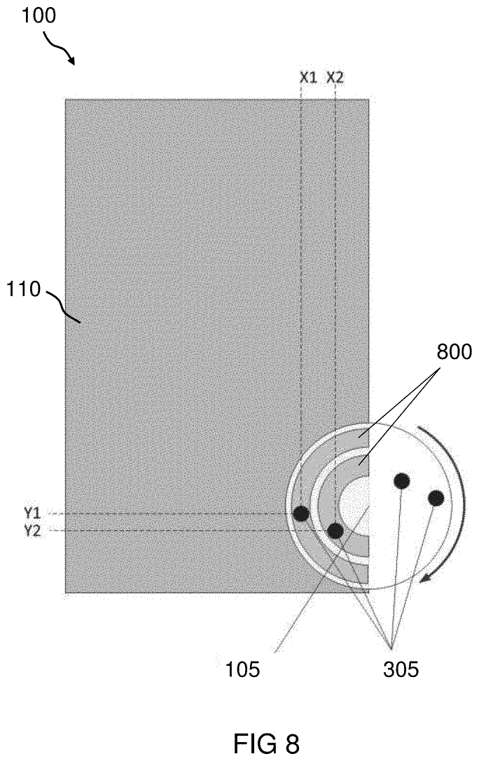

FIGS. 8-15 show a schematic illustration of a surface control device according to an exemplary embodiment; and

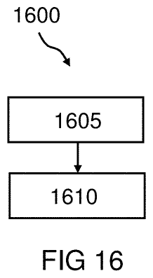

FIG. 16 shows a flow chart for a method for operating a touch-sensitive surface by means of a control device according to an exemplary embodiment.

In the following description of preferred exemplary embodiments of the present invention, the same or similar reference symbols are used for the elements in the various figures that have similar functions, wherein the descriptions of these elements will not be repeated.

If an exemplary embodiment comprises an “and/or” conjunction between a first feature and a second feature, this is to be read to mean that the exemplary embodiment according to one embodiment contains both the first feature and the second feature, and contains either just the first feature or just the second feature according to another embodiment.

FIG. 1 shows a schematic illustration of a surface control device 100 comprising a control device 105 for operating a touch-sensitive surface 110 in a vehicle according to an exemplary embodiment.

The surface control device 100 comprises the control device 105 and the touch-sensitive surface 110, wherein the control device 105 is moveably coupled to the surface 110.

The control device 105 has a navigating element 115. The navigating element 115 is or can be moveably coupled to the surface 110 and configured to be able to navigate on the surface 110, and/or operate at least one button on the surface 110, in response to a movement of the navigating element 115.

FIG. 2 shows a schematic illustration of the undersurface of a surface control device 100 according to an exemplary embodiment. This can be the surface control device 100 described in reference to FIG. 1.

FIG. 3 shows a schematic cross sectional view of a control device 105 according to an exemplary embodiment. This can be the control device 105 for the surface control device 100 described in reference to FIG. 1 or 2, which has further optional features.

The navigating element 115 for the control device 105 according to this exemplary embodiment has a dial 300. The navigating element 15 can also rotate and/or move linearly on the surface 110. The navigating element 115 has a number of conductive pins 305 that are in contact with the surface 110. The control device 105 according to this exemplary embodiment also has a keypad 310 in the navigating element 115. A push button function is obtained inside the dial 310 according to this exemplary embodiment by the keypad 310, which can also be referred to as keys, using an additional conductive pin 305 in the keypad. There is a pressure sensitive mat 315 in the keypad 310.

The features of the control device 105 and the surface control device 100 shall now be described differently in greater detail below:

Current touch-sensitive surfaces, also referred to as touchscreens, have obtained high resolutions, with exact and precise inputs, but can rarely be used, simply because of the size of a fingertip. This requires a great deal of attention on the part of the driver in order to correctly execute a desired action on the surface, which in turn distracts the driver.

The surface control device 100 presented herein can also be referred to as a so-called “Advance Touch Screen Navigator” or “Advance Haptic Touchscreen Navigator.” The surface control device 100 advantageously combines the convenient haptics of a conventional dial serving as the control device 105 with the numerous advantages of a touchscreen. This control device 105 enables an operation of defined functions that require more precision on the part of the driver. This can be achieved with the surface control device 100 without extra costs for an electronics system for the dial 300.

The following is a description of one technological solution for the surface control device 100:

A rotary switch serving as the control device 105 is placed directly above the multi-touch surface 110. There are numerous conductive pins 305 attached to the rotary switch itself, which are in permanent contact with the surface 110, which can also be referred to as a touchscreen, via a spring mechanism in the dial 300. As a result, the positions of the pins 305 and therefore the position and orientation of the dial 300 can be determined by the surface 110, and forwarded to a control unit for the surface 110.

The dial 300 can rotate and be slid upward on the surface 110, wherein various snap-in positions can be reached in different ways. The rotational and sliding movement is obtained according to this exemplary embodiment with a snap-in pin and a snap-in contour.

According to another exemplary embodiment, the control device 105 can also have other haptic control elements, in addition or as an alternative to the dial 300 and/or the keypad 310, e.g. at least one key and/or at least one slider, and/or at least one control lever. With a control lever, the movement is two dimensional.

FIG. 4 shows a schematic cross sectional view of a surface control device 100 according to an exemplary embodiment. This can be the surface control device 100 shown in FIG. 2 with the control device 105 described in reference to FIG. 3.

FIG. 5 shows a schematic side view of a surface control device 100 according to an exemplary embodiment. This can be the surface control device 100 described in reference to FIG. 4.

FIG. 6 shows a schematic rear view of a surface control device 100 according to an exemplary embodiment. This can be the surface control device 100 described in reference to FIG. 4 or FIG. 5.

It should be noted that a sliding movement of the control device 105 on the surface is obtained in FIG. 6 with a permanent magnet 600 and two metallic surfaces 605. The permanent magnet 600 is on a rear surface of a housing 610 in which the surface is accommodated. The metallic surfaces 605 are connected to the control device and encompass the permanent magnet 600.

FIG. 7 shows a perspective exploded illustration of a surface control device 100 according to an exemplary embodiment. This can be the surface control device 100 described in reference to FIG. 6. There is a control unit 700 between the surface 110 and the housing 610.

FIG. 8 shows a schematic illustration of a surface control device 100 according to an exemplary embodiment. This can be the surface control device 100 described in reference to FIG. 7, with the difference that the control device 105 is not positioned completely over the surface 110.

In order not to use too much space on the surface 110 for the control device 105, the dial according to this exemplary embodiment is not completely positioned over the surface 110. Because of the arrangement of the conductive pins 305 shown herein, a partial covering of the dial is sufficient. According to this exemplary embodiment, only half of the dial is covered by the surface 110.

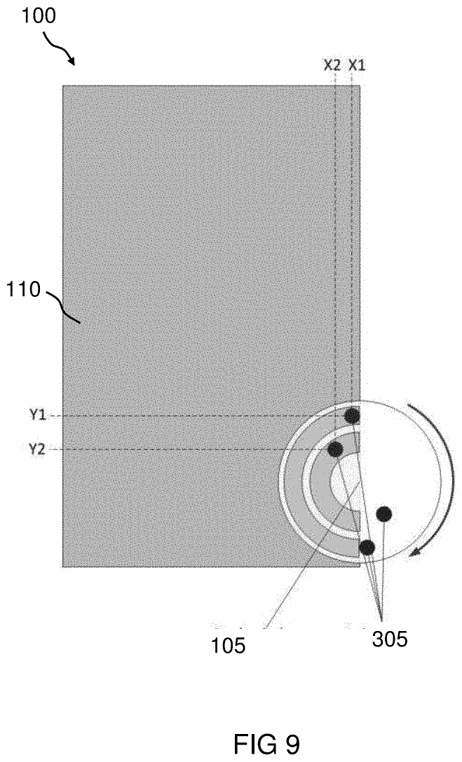

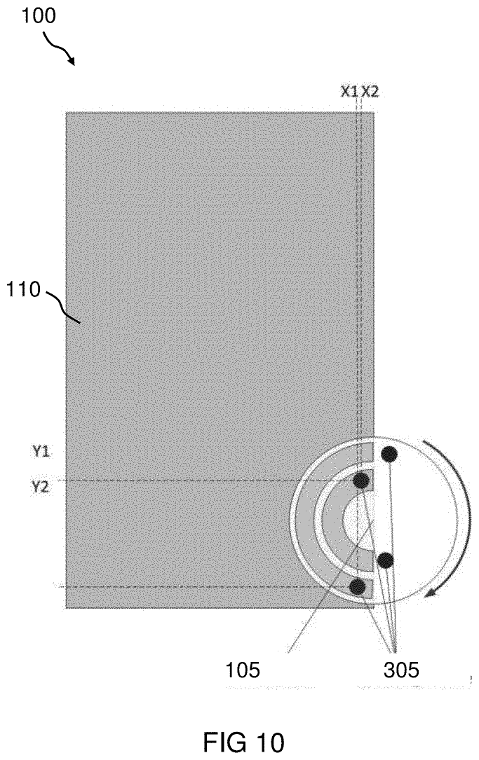

The pins 305 are arranged such that when a conductive pin 305 leaves the touchscreen area 800 a new conductive pin 305 slides in place, see FIGS. 9 and 10.

The multi-touch surface 110, usually a projecting capacitive touchscreen, is constructed from a dual-layer coordinate network made of electrodes, arranged in columns in one layer and rows in the other layer. In order to prevent potential hardware errors or malfunctions of individual rows or columns over the lifetime of this coordinate network, at least two conductive pins 305 are always in contact with the surface 100, each of which use different electrode rows and columns. As a result, a redundant signal is obtained that is necessary for safety-relevant systems such as ASIL A, and ASIL B.

It makes sense from a software perspective to concretely define the touchscreen areas 800 in this exemplary embodiment, which can also be referred to as the touchscreen surfaces, for the defined circular movements of the conductive pins 305. As a result, an unintentional rotation when sliding the dial can be detected and ignored. False external inputs can thus also be prevented, because the inputs must be executed precisely in the defined touchscreen areas 800 with the defined arrangement of the conductive pins 305.

According to this exemplary embodiment, the operation of the surface 110 through the movement of the control device 105 is therefore dependent on a contact position of at least one first pin 305 and/or a second pin 305 in the control device 105 on to the surface 110.

FIG. 9 shows a schematic illustration of a surface control device 100 according to an exemplary embodiment. This can be the surface control device 100 described in reference to FIG. 8, with the difference that the control device 105 is rotated.

FIG. 10 shows a schematic illustration of a surface control device 100 according to an exemplary embodiment. This can be the surface control device 100 described in reference to FIG. 9, with the difference that the control device 105 is rotated further.

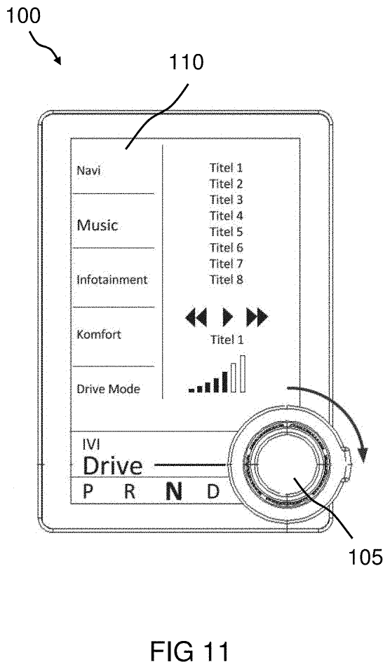

FIG. 11 shows a schematic illustration of a surface control device 100 according to an exemplary embodiment. This can be the surface control device 100 described in reference to any of the FIGS. 8 to 10, in which a display is shown in the region of the surface 110.

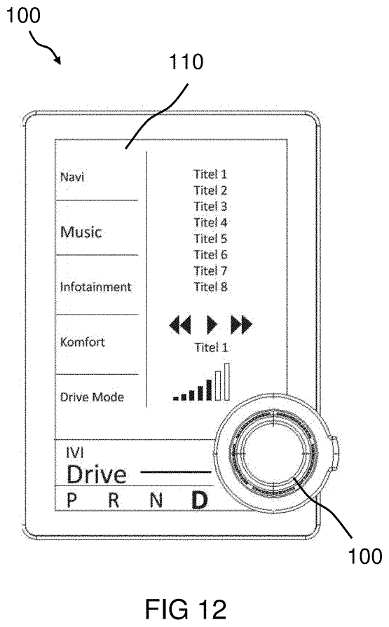

Various vehicle functions can be operated with the control device 105. According to this exemplary embodiment, a rotation of the control device 105 shifts gears from neutral N to drive D, as can be seen in FIG. 12.

FIG. 12 shows a schematic illustration of a surface control device 100 according to an exemplary embodiment. This can be the surface control device 100 described in reference to FIG. 11, which has been set to drive D by rotating the control device 105.

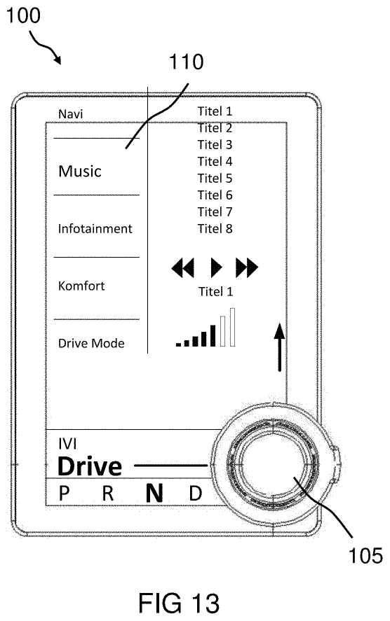

FIG. 13 shows a schematic illustration of a surface control device 100 according to an exemplary embodiment. This can be the surface control device 100 described in reference to FIG. 12, which changes to a control function of another vehicle function by sliding the control device 105 upward.

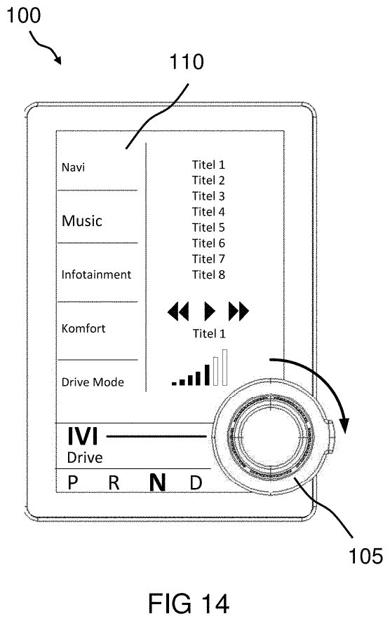

FIG. 14 shows a schematic illustration of a surface control device 100 according to an exemplary embodiment. This can be the surface control device 100 described in reference to FIG. 13, which then controls the second vehicle function through rotating the control device 105.

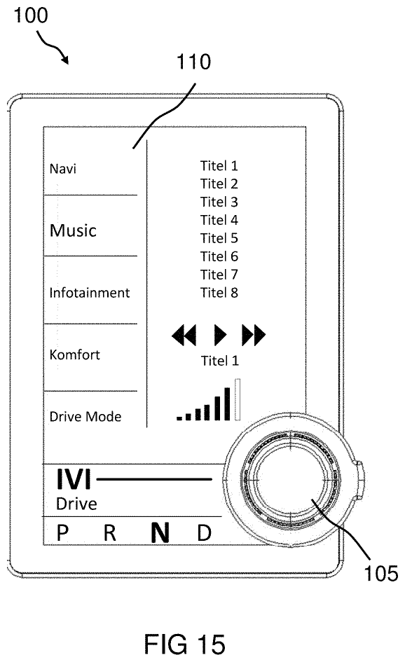

FIG. 15 shows a schematic illustration of a surface control device 100 according to an exemplary embodiment. This can be the surface control device 100 described in reference to FIG. 14, which increases the volume of an audio device through rotating the control device 105.

FIG. 16 shows a flow chart for a method 1600 for operating a touch-sensitive surface by means of a control device according to an exemplary embodiment. This can be the control device described in reference to any of the preceding figures. The method 1600 can be executed or initiated by the control unit shown in FIG. 7.

The method 1600 comprises an input step 1605 and an output step 1610.

A movement signal is input in the input step 1605 that represents a movement of the navigating element of the control device moveably coupled to the surface. A navigation signal is output in the output step 1610 for navigating on the surface and/or operating the buttons on the surface based on the movement signal.

The exemplary embodiments described herein and shown in the figures are selected merely by way of example. Different exemplary embodiments can be combined with one another in their entirety or with respect to individual features. An exemplary embodiment can also be supplemented by the features of another exemplary embodiment.

Furthermore, the steps of the method can also be repeated or executed in a sequence different from that in the description.

### REFERENCE SYMBOLS

100 surface control device
105 control device
110 touch-sensitive surface
115 navigating element
300 dial
305 pin
310 keypad
315 pressure sensitive mat
600 permanent magnet
605 metallic surface
610 housing
700 control unit
800 touchscreen area
1600 method for operating a touch-sensitive surface by means of a
control device
1605 input step
1610 output step

1. A control device (105) for operating a touch-sensitive surface (110) in a vehicle, wherein the control device (105) comprises:
a navigating element configured to be moveably coupled to the touch-sensitive surface; and
navigate on the touch-sensitive surface (110) and operate at least one button on the touch-sensitive surface (110) in response to at least one movement of the navigating element.

2. The control device (105) according to claim 1, wherein the navigating element is configured to be rotated and moved linearly on the touch-sensitive surface (110).

3. The control device (105) according to claim 1, wherein the navigating element comprises at least one of a dial, a slider, or a control lever.

4. The control device (105) according to claim 1, wherein the navigating element comprises at least one pin (305) that is configured to come in contact with the touch-sensitive surface (110) when the navigating element (115) is coupled to the touch-sensitive surface (110).

5. The control device (105) according to claim 1, further comprising:
a keypad accommodated in the navigating element (115).

6. A surface control device comprising the control device (105) according to claim 1.

7. The surface control device (100) according to claim 6, wherein an operation of the touch-sensitive surface (110) through the at least one movement of the navigating element is dependent on a defined contact position of at least one first pin (305) and a second pin of the navigating element (115) on the touch-sensitive surface (110).

8. A method (1600) for operating a touch-sensitive surface comprising:
inputting (1605) a movement signal representing a movement of a navigating element (115) of a control device (105) moveably coupled to the touch-sensitive surface (110); and
outputting (1610) a navigation signal to at least one of navigate on the touch-sensitive surface or operate a button on the touch-sensitive surface (110) based on the movement signal.

9. (canceled)

10. A non-transitory computer-readable medium having stored thereon a computer program that, when executed by a computing device, causes the computing device to perform a method comprising:
inputting a movement signal representing a movement of a navigating element of a control device moveably coupled to a touch-sensitive surface; and
outputting a navigation signal to at least one of navigate on the touch-sensitive surface or operate a button on the touch-sensitive surface based on the movement signal.

11. The non-transitory computer-readable medium according to claim 10, wherein the movement signal represents at least one of a rotation or a linear movement of the navigation element on the touch-sensitive surface.

12. The non-transitory computer-readable medium according to claim 10, wherein the navigation element comprises at least one of a dial, a slider, or a control lever.

13. The non-transitory computer-readable medium according to claim 10, wherein the computer program causes the computing device to perform the method further comprising:
operating the touch-sensitive surface dependent on defined contact positions of a first pin and a second pin of the navigating element on the touch-sensitive surface.

14. The method according to claim 8, wherein the movement signal represents at least one of a rotation or a linear movement of the navigation element on the touch-sensitive surface.

15. The method according to claim 8, wherein the navigation element comprises at least one of a dial, a slider, or a control lever.

16. The method according to claim 8, further comprising:
contacting the touch-sensitive surface with a first pin and a second pin of the navigating element.

17. The method according to claim 16, further comprising:
operating the touch-sensitive surface dependent on defined contact positions of the first pin and the second pin on the touch-sensitive surface.
